(19) United States
(12) Patent Application Publication
(10) Pub. No.: US 2013/0262508 A1
(43) Pub. Date: Oct. 3, 2013

(54) GRAPHIC SEARCH APPARATUS AND METHOD

(71) Applicant: FUJITSU LIMITED, Kawasaki-shi (JP)

(72) Inventor: Ryoichi YAMASHITA, Yokohama (JP)

(21) Appl. No.: 13/739,017

(22) Filed: Jan. 11, 2013

(30) Foreign Application Priority Data
Mar. 28, 2012 (JP) 2012-075125

(51) Int. Cl. G06F 17/30

(52) U.S. Cl. CPC G06F 17/30247
USPC 707/769

(57) ABSTRACT

A graphic search apparatus is disclosed. A storage part stores first trace information including information pertinent to graphic data. The first trace information is acquired by tracing sets of the graphic data included in a search range based on a sort result from sorting the sets of the graphic data included in the search range. One of multiple areas included in a predetermined area is set as the search range. A control part starts from beginning graphic data corresponding to the information included in the first trace information stored in the storage part, searches for the graphic data toward an adjacent search range to the search range including the beginning graphic data, and controls a process for updating the first trace information.

### CROSS-REFERENCE TO RELATED APPLICATIONS

This patent application is based upon and claims the benefit of priority of the prior Japanese Patent Application No. 2012-075125 filed on Mar. 28, 2012, the entire contents of which are incorporated herein by reference.

### FIELD

The embodiment discussed herein is related to performing of a graphic search at a higher speed.

### BACKGROUND

In a design of an LSI (Large Scale Integration), a large amount of graphic data of two dimensional space is managed and the graphic data are searched for, in which the graphic data represent wirings, vias, and the like pertinent to fabrication of the LSI. A large amount of the graphic data of the two dimensional space, which include various shapes and scales, is managed. In the graphic search with respect to the graphic data being managed, target graphic data are searched for by tracking the graphic data to next graphic data (hereinafter, called “trace”).

In order to realize a high speed search, an area of the two dimensional space, in which the graphic data exist, is recursively divided into four areas (cells or buckets) (a quad-tree), and the graphic data are stored and managed for each of cells, so as to reduce an amount of the graphic data in a search range. Also, in order to increase efficiency of search, a search is conducted by divide-and-conquer. The entire graphic data are sorted based on reference coordinates. After that, data included in a trace range to be a process target are divided into smaller areas.

### Patent Documents

Japanese Laid-open Patent Publication No. H02-156379

Japanese Laid-open Patent Publication No. 2007-233658

Japanese Laid-open Patent Publication No. 2009-104755

Japanese Laid-open Patent No. 3649430

### SUMMARY

According to one aspect of the embodiment, there is provided a graphic search apparatus, including a storage part configured to store first trace information including information pertinent to graphic data, the first trace information being acquired by tracing sets of the graphic data included in a search range based on a sort result from sorting the sets of the graphic data included in the search range in which one of multiple areas included in a predetermined area is set as the search range; and a control part configured to start from beginning graphic data corresponding to the information included in the first trace information stored in the storage part, to search for the graphic data toward an adjacent search range to the search range including the beginning graphic data, and to control a process for updating the first trace information.

According to other aspects of the embodiment, there may be provided a non-transitory computer-readable recording medium to cause a computer to function as the above described graphic search apparatus, and a graphic search method.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating examples of wiring layers;

FIG. 2A and FIG. 2B are diagrams illustrating examples of graphics of wirings;

FIG. 3 is a diagram illustrating one aspect of a concept in a case in which line data are sorted by coordinates;

FIG. 4A, FIG. 4B, and FIG. 4C are diagrams for explaining a sort example;

FIG. 5 is a diagram illustrating a data structure example of a metal data table;

FIG. 6 is a diagram illustrating a data structure of a VIA data table;

FIG. 7 is a diagram illustrating an aspect in a case of creating a trace table of a x-direction wiring layer;

FIG. 8 is a diagram illustrating examples of a Max length and a Max width;

FIG. 9 is a diagram illustrating a data structure example of a trace table;

FIG. 10 is a diagram for explaining a relationship between a search range and graphic data;

FIG. 11A and FIG. 11B are diagrams for explaining a search method;

FIG. 12 is a diagram for explaining the search method using a local trace table (part 1);

FIG. 13 is a diagram for explaining the search method using the local trace table (part 2);

FIG. 14 is a diagram illustrating a data structure example of the local trace table;

FIG. 15 is a diagram illustrating a hardware configuration of a graphic search apparatus;

FIG. 16 is a diagram illustrating a functional configuration example of the graphic search apparatus;

FIG. 17 is a flowchart for briefly explaining a graphic search process;

FIG. 18 is a flowchart for explaining the graphic search process in detail;

FIG. 19 is a flowchart for explaining a creation process of a trace table in step S13 in FIG. 18;

FIG. 20 is a flowchart for explaining a trace reduction process in step S15 in FIG. 18;

FIG. 21 is a flowchart for explaining a graphic data reduction process in step S18 in FIG. 18;

FIG. 22 is a flowchart for explaining a process in step S21 in FIG. 18;

FIG. 23A and FIG. 23B are diagrams for explaining a link update; and

FIG. 24 is a diagram illustrating a comparison of a process time.

### DESCRIPTION OF EMBODIMENTS

In the following, embodiments of the present invention will be described with reference to the accompanying drawings.

In a case of searching for a graphic, in general, graphic data existing in a narrow range are searched for. If a data scale becomes greater, layers dividing areas become deep, and a division number is increased. Processes are increased to reach target graphic data to be searched for. Thus, search speed is reduced.

In a case in which the graphic data straddling multiple areas exist, the following two types of methods are presented to store the graphic data:
(1) method for storing the graphic data in an area (cell) of an upper layer able to store the graphic data, instead of dividing the graphic data, and
(2) method for dividing and managing the graphic data so as to set it in an area of the lowest layer.

If there are many sets of the graphic data straddling the multiple areas, in the above method (1), a large number of sets of the graphic data not being a target of the search area may exist. In this case, there may be problem in which processes may be increased to specify the graphic data which exist in the search range for the graphic data existing in the upper layer.

Also, in the above method (2), by dividing the graphic data, the number of sets of the graphic data to be management targets is increased. For example, a large variety of wiring graphics such as wires connecting from an edge to another edge of an area, wires of micro sections, and the like in the graphic data used as fabrication data of a LSI (Large Scale Integration). In a case of applying the above method (2) in the graphic data, the scale of the graphic data may be extremely increased two times or more.

A method may be considered to search for a target range by sorting the graphic data by a binary search. Considering a large scale of data, compared with a quad-tree method, efficiency of the search in this method may be further degraded.

Also, in a verification process of the fabrication data of the LSI or the like, graphics are searched for by shifting a local area in the entire area, and it is checked whether or not there is a problem with respect to a design rule. In a case in which the data scale is enormous, an area reduction process is demanded for each search, and overhead of a search process becomes greater.

By applying the embodiment described below, in a graphic search, a search is performed at higher speed in a local area near a search start.

In a case in which a variety of graphics such as the fabrication data of the LSI exist and the scale of the graphic data (the number of the sets of the graphic data) is large, in the embodiment, the graphics included in the local area are searched for at higher speed, and an increase of memory for the graphic search is suppressed. In an operation of the graphic search by shifting the local area in the entire area, the graphic search is efficiently performed.

In the following, a graphic search method according to the embodiment will be described. In the graphic search method, in order to search for a specific graphic in two dimensional graphic data pertinent to the LSI formed by multiple wiring layers, the graphic search is performed by using following two types of reductions.

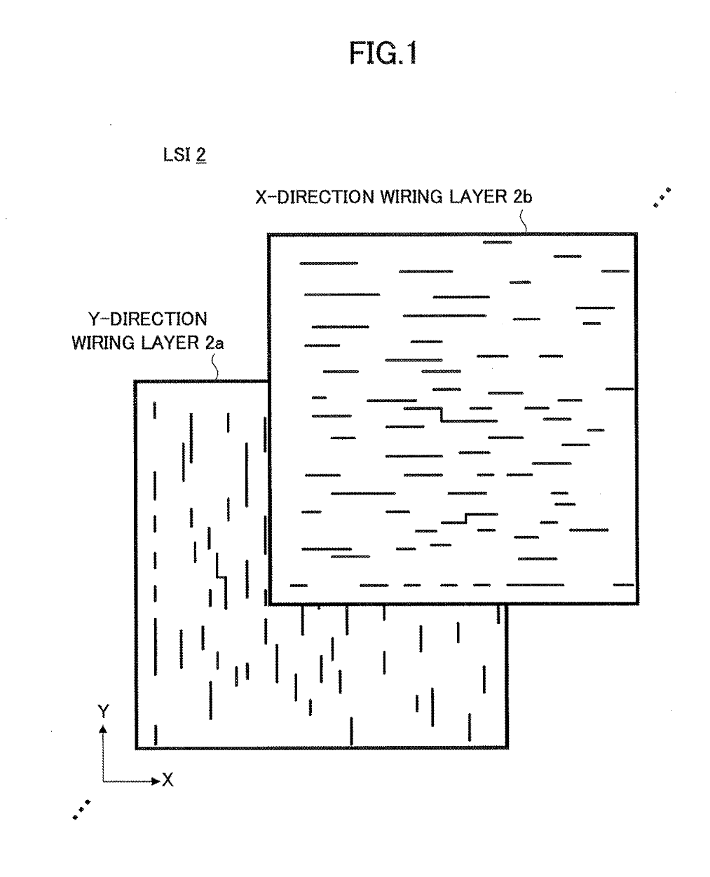

In a LSI 2 illustrated in FIG. 1, a y-direction wiring layer 2a and a x-direction wiring layer 2b are alternately laminated for wiring. In the y-direction wiring layer 2a, the wiring is formed in a y-direction. In the x-direction wiring layer 2b, the wiring is formed in a x-direction. For the graphic data related to wirings and vias of the LSI 2, the following reductions are conducted.

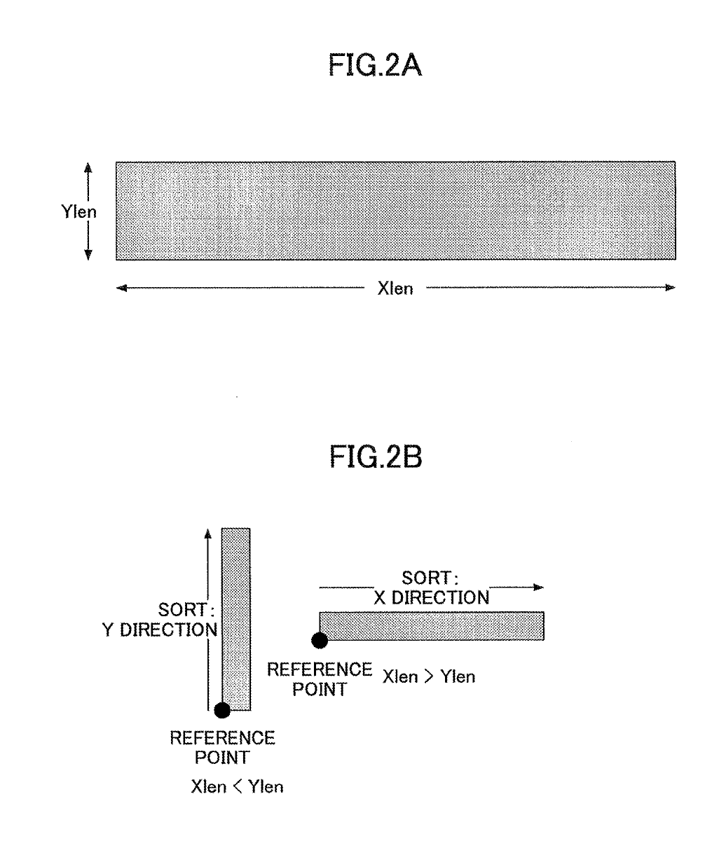

(1) The entire graphic data are arrayed by a one dimensional simple sort. The entire graphic data are sorted based on a wiring direction and a reference point (FIG. 2B) defined beforehand.

(2) A trace table is created so that the graphic data sorted in the above item (1) are classified into groups. With respect to the x-direction wiring layer 2b, the graphic data having the same y-coordinate are classified into the same group. Similarly, with respect to the y-direction wiring layer 2a, the graphic data having the same x-coordinate are classified into the same group. Each of the same y-coordinate with respect to the x-direction wiring layer 2b and the same x-coordinate with respect to the y-direction wiring layer 2a is simply called a “same trace”. A trace direction is a direction of tracing the graphic data from one to another in the x-direction or in the y-direction, and corresponds to a wiring direction.

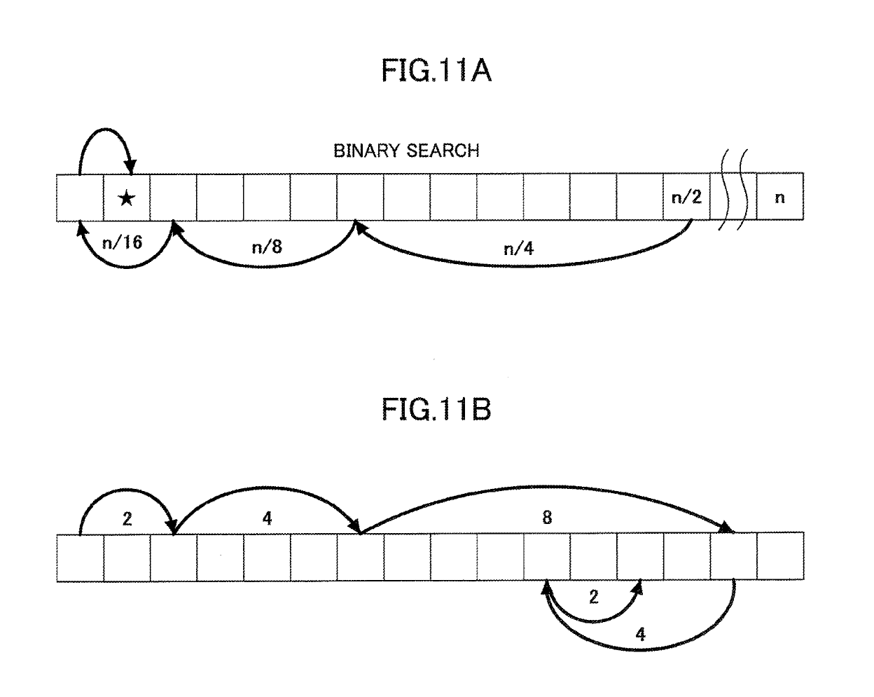

Also, to search for line data for the same traces, the following is applied.
(2-1) a skip search is applied in a case of shifting the local area (FIG. 11B), or
(2-2) a binary search is applied in a case of a single search (FIG. 11A)

Especially, by combining the skip search in the case of shifting the local area as described above (2-1), and a local use of the trace table as described above (1), it is possible to perform a search independent of a total number of sets of data. Accordingly, it is possible to effectively conduct a reduction process of a search area.

In a case of the binary search, a process time is represented by O(log n). In a case of a quad-tree, the process time is represented by O(log n). However, in the combination of the skip search and a local trace table, in a case in which a search target exists near a search start point, it is possible to search for the search target at a calculation time independent of the total number of sets of the graphic data.

### [1] Sort of Graphic Data

First, the graphic data are sorted based on coordinates. Along the wiring direction, xy coordinates (bottom left coordinates) at a bottom left of a graphic are used as the reference point, and the graphic data are sorted by the reference point.

FIG. 2A and FIG. 2B are diagrams illustrating graphic examples of the wiring. In the graphic example of the wiring illustrated in FIG. 2A, a length in the x-direction is indicated by Xlen, and a length in the y-direction is indicated by Ylen. Similarly, lengths of the via in the x-direction and the y-direction are indicated. In FIG. 2B, a determination method of the trace direction is described. In FIG. 2B, when Xlen is shorter than Ylen (Xlen<Ylen), the trace direction is determined as the y-direction. On the other hand, when Xlen is greater than Ylen (Xlen>Ylen), the trace direction is determined as the x-direction. When Xlen is equal to Ylen (Xlen=Ylen), the trace direction is determined beforehand as either the x-direction or the y-direction. The reference point is set at the bottom left coordinates in any case.

In accordance with the determined trace direction, the graphic data are sorted by using the reference point of the graphic. As a sort method, two types of methods are considered: a method for directly sorting the graphic data, and another method for sorting indexes pointing to graphic data. Either one of methods may be applied.

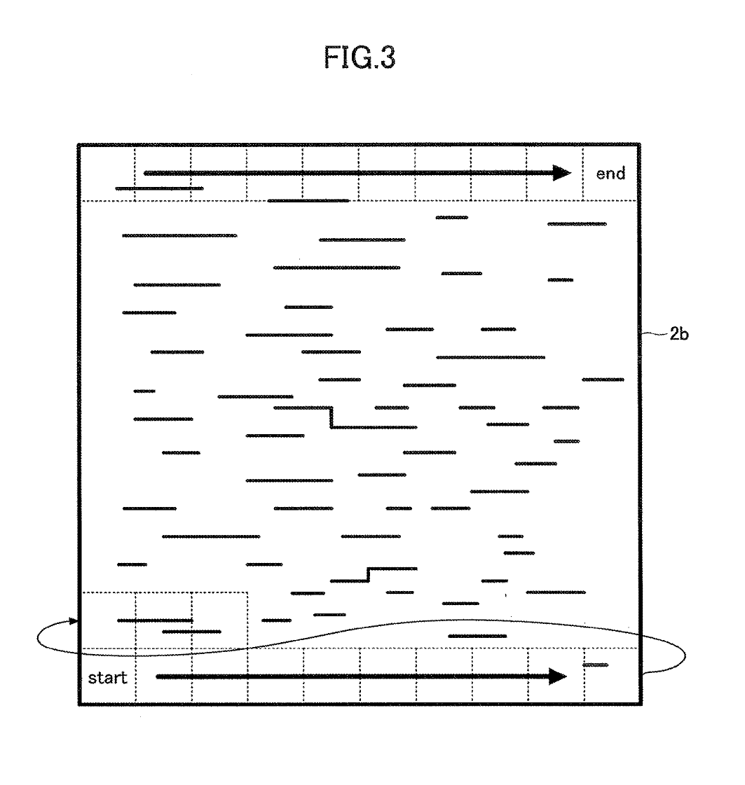

An example of sorting the graphic data will be described. FIG. 3 is a diagram illustrating one aspect of a concept in a case in which line data are sorted by the coordinates. In FIG. 3, in a case of the x-direction wiring layer 2b, the graphic data are sorted in an order starting from the graphic data at the bottom left and ending at the graphic data at a top right.

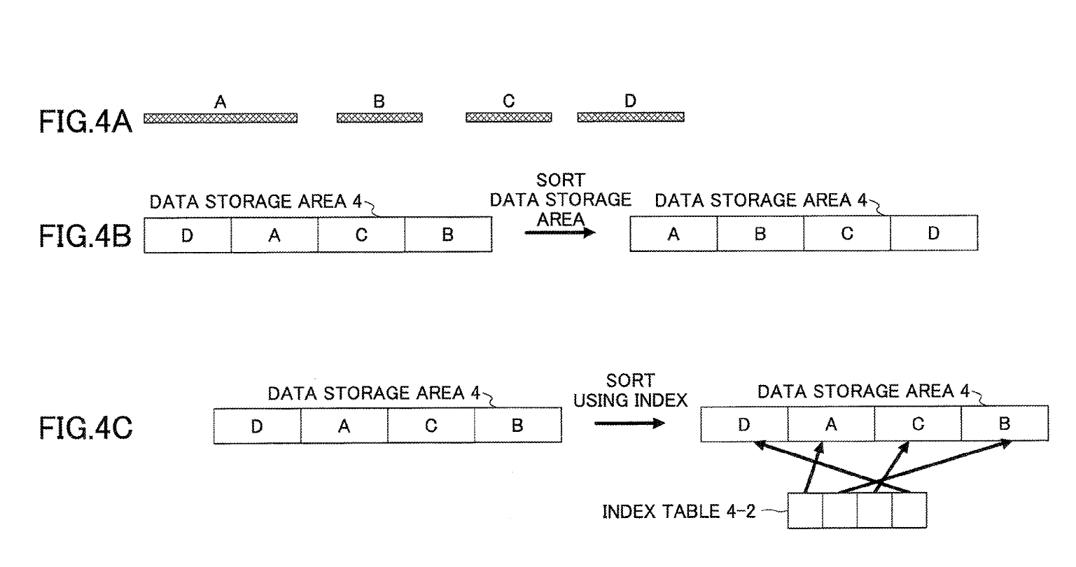

FIG. 4A, FIG. 4B, and FIG. 4C are diagrams for explaining a sort example. FIG. 4A illustrates an arrangement example of the wiring for one row of the x-direction wiring layer 2b. Wirings A, B, C, and D are arranged from left to right in this order.

FIG. 4B illustrates an example of directly sorting the line data formed by the wirings A, B, C, and D in FIG. 4A within a data storage area 4. In FIG. 4B, the line data in an order of the wirings D, A, C, and B are directly sorted in the data storage area 4 based on the reference point. The line data are arranged and stored in the data storage area 4 in the order of wirings A, B, C, and D.

FIG. 4C illustrates an example of sorting an index table 4-2 indicating the wirings D, A, C, and B by the indexes, instead of directly sorting the line data stored in the data storage area 4 in the order of the wirings D, A, C, and B. By the sorted indexes, the order of the wirings A, B, C, and D is indicated. In this sort example, the order of the wirings D, A, C, and B stored in the data storage area 4 is not changed.

Next, the trace table will be explained.

### [2] Trace Table

In a case in which a data amount becomes enormous, the search area is reduced, and with an aim to improve search efficiency, the trace table is created to classify the sets of the graphic data into the groups each having the same trace. In a case of the x-direction wiring layer 2b, the y-coordinate is set as a trace coordinate. In a case of the y-direction wiring layer 2a, the x-coordinate is set as the trace coordinate.

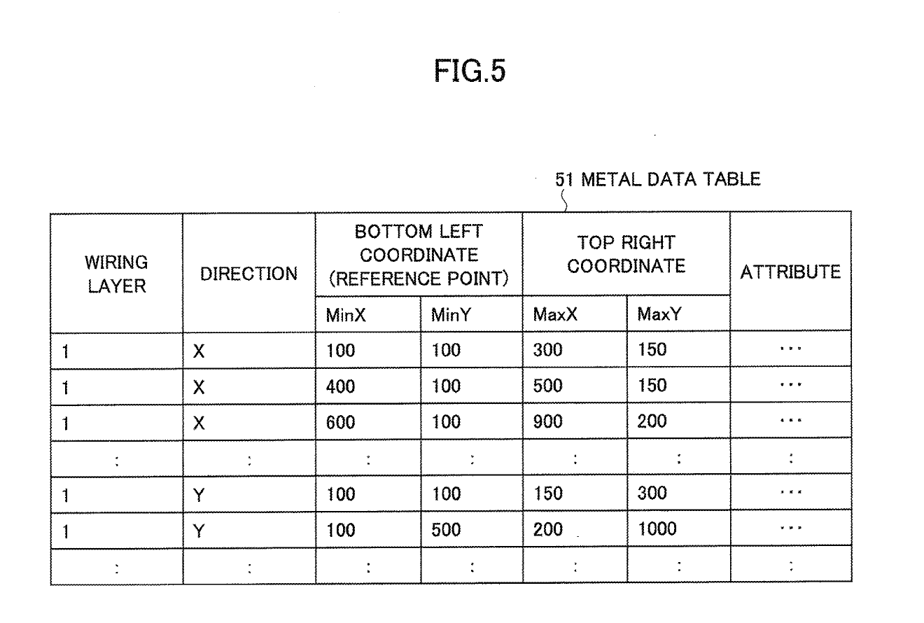

First, an example of a data table will be described. The data table is referred to when the trace table is created. FIG. 5 is a diagram illustrating a data structure example of a metal data table. A metal data table 51 illustrated in FIG. 5 is used to store data for each wiring, and includes items of a wiring layer, a direction, bottom left coordinate (the reference point), top right coordinate, an attribute, and the like.

A value of the wiring layer specifies one layer in a multilayer. In the direction, a value is “Y” in a case of the y-direction wiring layer 2a, and is “X” in a case of the x-direction wiring layer 2b. The bottom left coordinate is indicated by coordinates (MinX, MinY) at the bottom left of the wiring, and is used as the reference point. The top right coordinate is indicated by coordinates (MaxX, MaxY) of the top right of the wiring. The attribute indicates an electric property of the wiring and the like. A width Xlen of the wiring is acquired by MinX and MaxX, and a width Ylen of the wiring is acquired by MinY and MaxY.

The data structure example in FIG. 5 indicates that a wiring layer “1” is the x-direction wiring layer 2b, and on the wiring layer “1”, a wiring specified by the bottom left coordinates (100, 100) and the top right coordinates (300, 150), a wiring specified by the bottom left coordinates (400, 100) and the top right coordinates (500, 150), a wiring specified by the bottom left coordinates (600, 100) and the top right coordinates (900, 200), and the like are disposed.

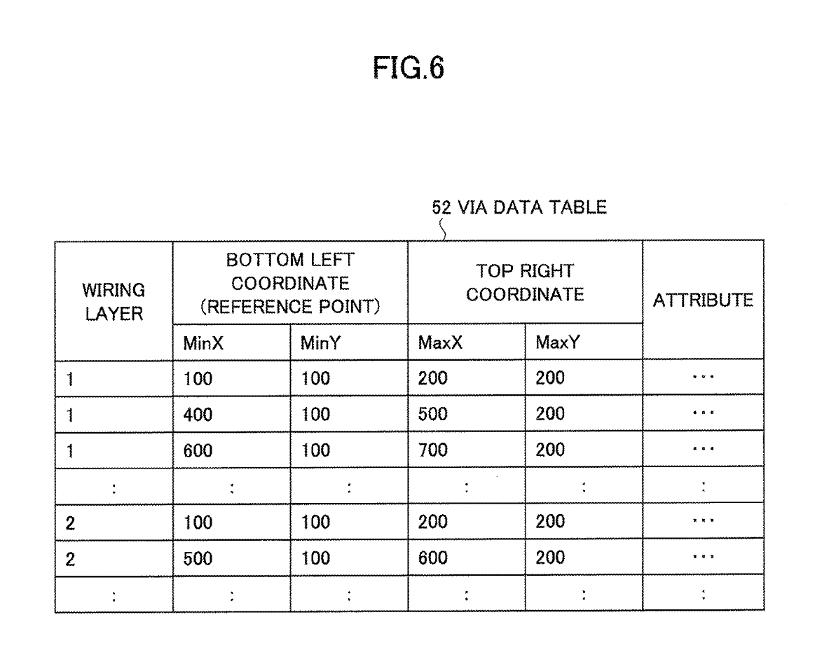

FIG. 6 is a diagram illustrating a data structure example of a VIA data table. A VIA data table 52 illustrated in FIG. 6 is used to store data for each via, and includes items of a wiring layer, a bottom left coordinate (reference point), a top right coordinate, an attribute, and the like.

A value of the wiring layer specifies one layer in a multilayer. The bottom left coordinate is indicated by coordinates (MinX, MinY) at the bottom left of the via, and is used as the reference point. The top right coordinate is indicated by coordinates (MaxX, MaxY) of the top right of the via. The attribute indicates an electric property of the via and the like. A width Xlen of the via is acquired by MinX and MaxX, and a width Ylen of the via is acquired by MinY and MaxY.

The data structure example in FIG. 6 indicates that on the wiring layer “1”, a via specified by the bottom left coordinates (100, 100) and the top right coordinates (200, 200), a via specified by the bottom left coordinates (400, 100) and the top right coordinates (500, 200), a via specified by the bottom left coordinates (600, 100) and the top right coordinates (700, 200), and the like are disposed.

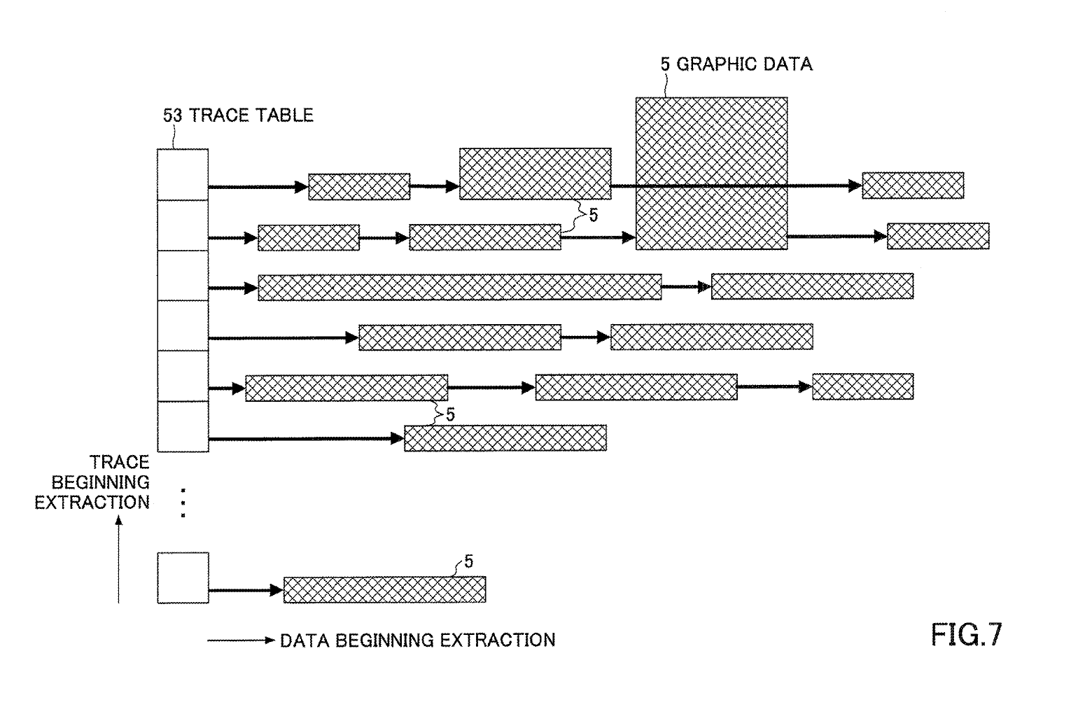

As described above, the metal data table 51 and the via data table 52 are sorted for each of the wiring layers in which the bottom left coordinate is set as the reference point, and the graphic data having the same trace coordinates are classified into the same group. FIG. 7 is a diagram illustrating an aspect in a case of creating a trace table 53 of the x-direction wiring layer 2b. As illustrated in FIG. 7, by the trace table 53 of the x-direction wiring layer 2b, graphic data 5 are classified into multiple groups each having the same y-coordinate.

The graphic data 5 in the same group are sorted based on the reference point, and are depicted in a state of linking from left to right.

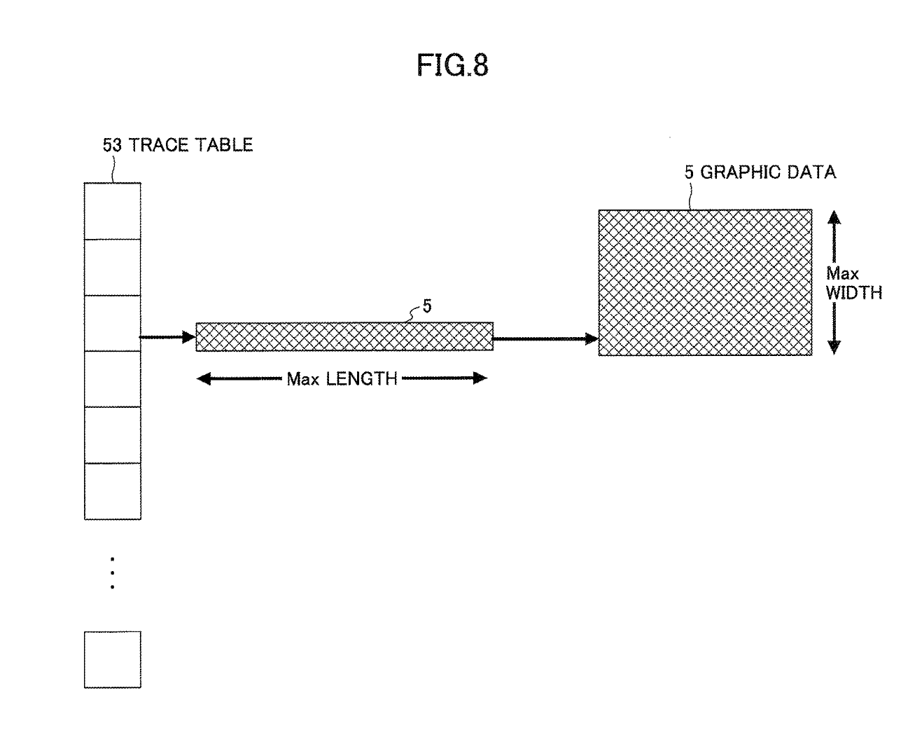

Also, as illustrated in FIG. 8, the trace table 53 being created stores a Max length indicating a maximum length and a Max width indicating a maximum width in the graphic data 5 for each of groups.

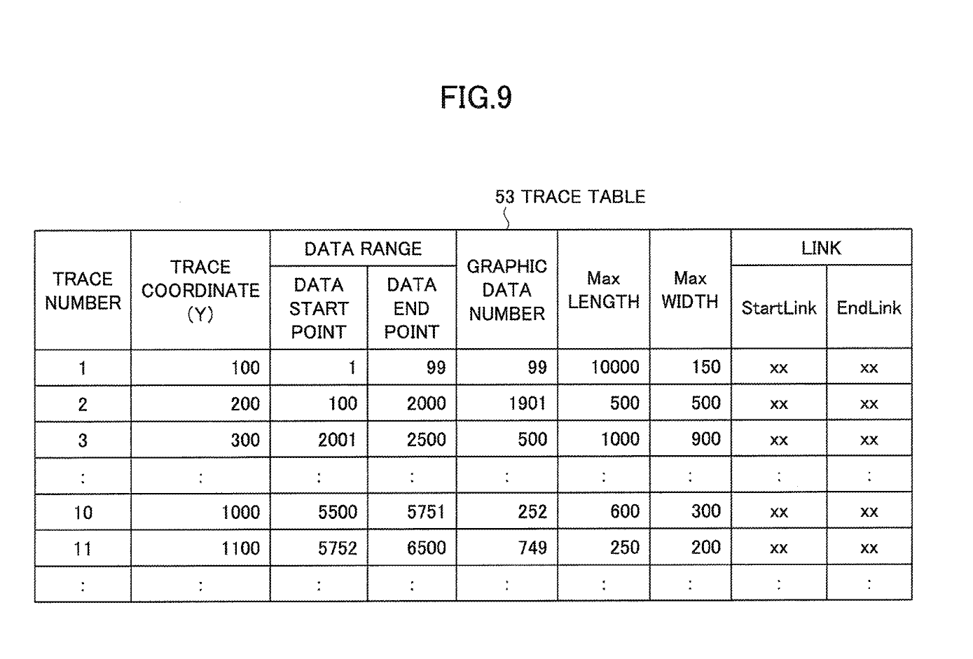

FIG. 9 is a diagram illustrating a data structure example of the trace table 53. In FIG. 9, the trace table 53 is used to store and manage data pertinent to a trace for each of the groups, and includes items of a trace number, a trace coordinate (Y), a data range, a graphic data number, a Max length, a Max width, a link, and the like.

The trace number indicates a number for identifying each of traces. The trace coordinate (Y) indicates the y-coordinate of the graphic data for grouping. The data range includes a data start point and a data end point. The data start point indicates a smallest value of the y-coordinate being the reference point in the same trace in the graphics being disposed. The data end point indicates a greatest value of the y-coordinate being the reference point in the same trace in the graphics being disposed.

The graphic data number indicates the number of sets of the graphic data 5 in the same trace. The Max length indicates a longest length in lengths Xlen of the graphic data 5 in the same trace. The Max width indicates a greatest width in widths Ylen of the graphic data 5 in the same trace. The Max length and the Max width are used to reduce the search range.

The link includes a StartLink for specifying the graphic data 5 initially being linked in the same trace and an EndLink for specifying the graphic data 5 ultimately being linked in the same trace. In the sets of the graphic data 5 including the y-coordinate of a range (a trace coordinate range) indicated by the trace coordinate (Y), a graphic data number, which specifies the graphic data 5 having a minimal x-coordinate of the reference point (that is, the graphic data 5 of a beginning of the trace), is set to the StartLink. The graphic data number, which specifies the graphic data 5 having a maximum x-coordinate of the reference point, is set to the EndLink. The link between the sets of the graphic data 5 in each trace may conform to a sorted order.

In the data structure example described above, the graphic data number may be acquired based on the StartLink and the EndLink. Also, if the graphic data number and the StartLink are indicated, the EndLink may be calculated. For the sake of convenience, the trace table 53 is formed to include the StartLink and the EndLink. Any one of the graphic data number, the StartLink, and the EndLink may be omitted.

The trace table 53 illustrated in FIG. 9 indicates an example of a structure in which each trace has a certain width. The coordinate values may be managed by the trace table 53 with predetermined intervals (for example, every 100).

### [3] Search Method

In general, the search process searches for target graphic data by indicating a target rectangular area. A relationship between the search range and the graphic data 5 in a case of using the trace table 53 will be described.

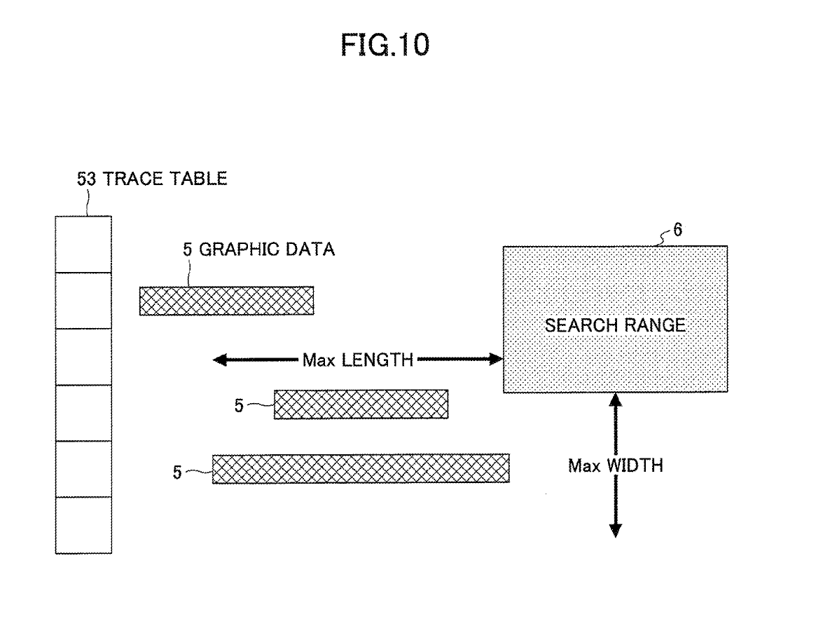

FIG. 10 illustrates a diagram for explaining the relationship between the search range and the graphic data 5. In an example in FIG. 10, when the graphic data 5 contacting an area of a search range 6 are extracted, the Max width is used to check whether the y-coordinate of the reference point is included in the search range 6 (trace reduction). If the Max width does not reach the search range 6, the traces in a range of the Max width are not demanded to be checked (skip).

The Max length is used to reduce a range of the x-coordinate (graphic data reduction). The graphic data 5, which have the x-coordinate as a start point at a distance greater than the Max length, are neglected (skip). Also, by storing not only the Max width in the trace but also another Max width of the entire traces on its wiring layer in the trace table 53, it is possible to easily reduce the sets of the graphic data 5 to be targets for the search range 6. That is, high speed reduction is realized.

The binary search or the skip search (described later) is performed for the search in the x-direction in each of the traces. Either one of search methods is applied as follows: the binary search is used for only one search, and the skip search is used for successively searching by shifting a local range.

FIG. 11A and FIG. 11B are diagrams for explaining the methods. In FIG. 11A, an example of the binary search is depicted. In the binary search, when n indicates a number of the graphic data 5 to be targets for the search range 6, the targets are searched for with a movement amount of n/2̂i (i=1, 2, 3, . . . ).

In FIG. 11B, an example of the skip search is depicted. Until the skip search reaches a target from the search start point, or until the skip search passes the target, the movement amount is increased by 2, 4, 6, 8, or the like. When the skip search passes the target, similar to the binary search, the skip search decreases the movement amount. In this example, the movement amount is varied by a multiple of 2. Alternatively, a multiple of 3, 4, or the like may be selected.

In the skip search, if the target exists near the search start point, the target is efficiently searched faster than the binary search. A movement count in the binary search depends on the data number n. On the other hand, the movement count in the skip search is independent of the data number n.

### [4] Local Trace Table

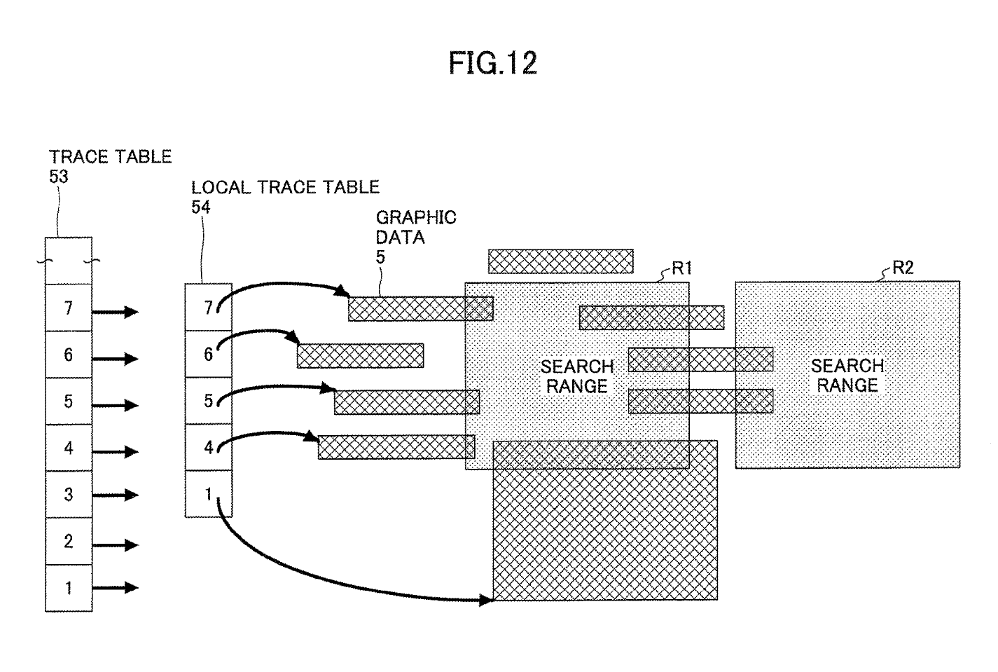

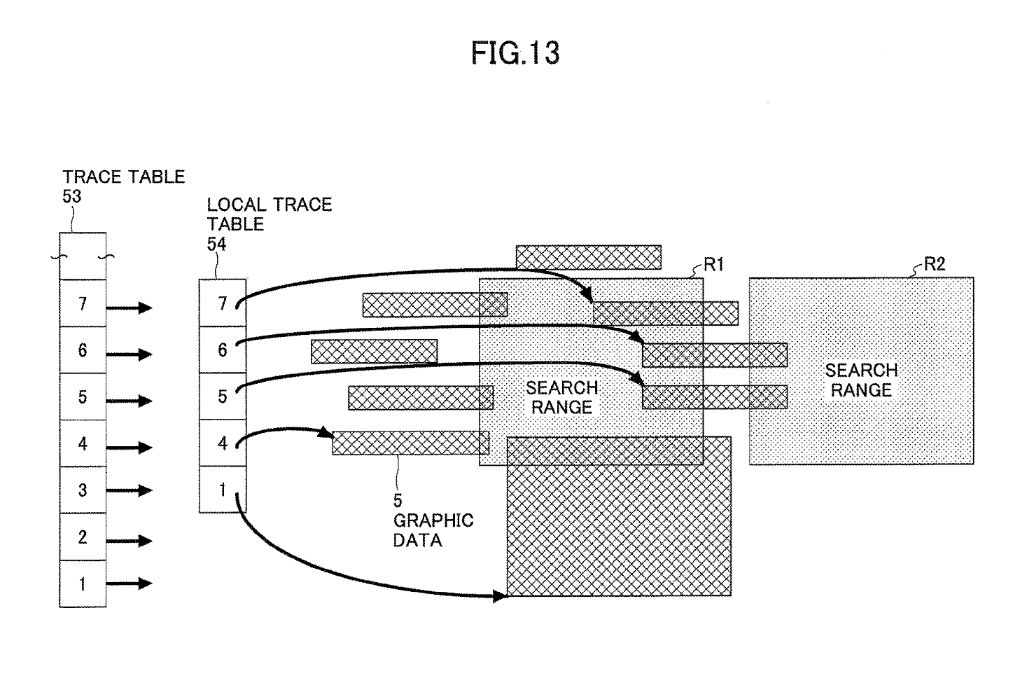

A search is conducted by shifting the local area by using the local trace table. FIG. 12 and FIG. 13 are diagrams for explaining the search method using the local trace table. In FIG. 12 and FIG. 13, a relationship among the trace table 53, a local trace table 54, and the graphic data 5 is depicted in a case of shifting from a search range R1 to a search range R2. Trace numbers 1, 2, 3, . . . alone are simply depicted in the trace table 53.

The local trace table 54 is used to retain information of the trace related to the search range, and information of links to the graphic data 5 in which a coordinate value of the reference point is smaller than the search range and contacts the search range, and the graphic data 5 in which the graphic is determined to exist near the search range in its size.

FIG. 12 depicts a case of processing the search range R1 before changing from the search range R1 to the search range R2. The local trace table 54 as illustrated in FIG. 12 indicates the links to the graphic data 5 (the trace numbers 4, 5, 6, and 7) in which a coordinate value of the reference point is smaller than the search range R1 and contacts the search range R1, and the graphic data 5 (the trace number 1) in which the graphic is determined to exist near the search range R1 in its size. The local trace table 54 retains the trace numbers 1, 4, 5, 6, and 7. On the other hand, the sets of the graphic data 5 corresponding to other trace numbers 2, 3, and the like do not contact the search range R1, and are not registered in the local trace table 54.

When changing from the search range R1 to the search range R2, as illustrated in FIG. 13, the local trace table 54 links to graphic data 5 in which a coordinate value of the reference point is smaller than the search range R2 and contacts the search range R2, and the graphic data 5 in which the graphic is determined to exist near the search range R2 in its size. The trace numbers 1, 4, 5, 6, and 7 are retained in the local trace table 54. On the other hand, the sets of the graphic data 5 corresponding to other trace numbers 2, 3, and the like do not contact the search range R2, and are not registered in the local trace table 54.

In an initial search, as illustrated in FIG. 12, for the graphic data 5 being the target for the search range R1, the trace number and the link of the graphic data 5 are retained in the local trace table 54. In a case in which the trace direction of the search range R2 is not changed at a next search, or in a case in which a trace coordinate range is included in a previous trace range even if the trace direction is changed, a vicinity search is performed by the skip search using contents of the local trace table 54 being previously stored. This search result is stored for a next search.

In a case of performing the search shifting the local area, by combining the local trace table 54 and the skip search, it is possible to effectively reduce the number of the sets of the graphic data 5 to be the targets. Also, it is possible to realize a significantly higher speed search for the large scale data.

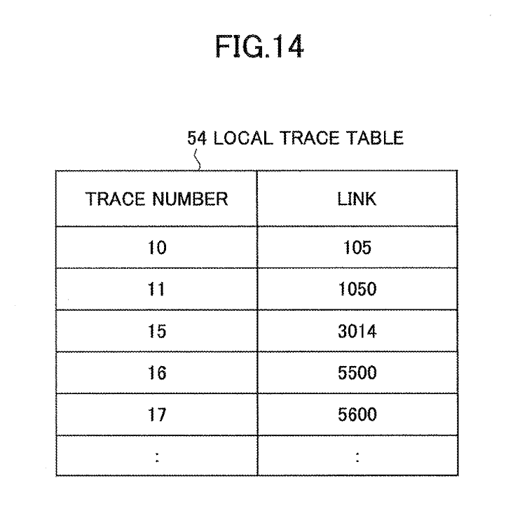

FIG. 14 is a diagram illustrating a data structure example of the local trace table 54. In FIG. 14, the local trace table 54 includes items of a trace number, a link, and the like. The trace table 53 is referred to by using the trace number of the local trace table 54, and data such as the data range (the data start point and the data end point), the Max length, the Max width, and the like are referred to, so as to store and manage the links to the graphic data 5 to be the targets.

In a case of creating the index table 4-2 (FIG. 4C), each link indicates the index (which may correspond to the number of the graphic data 5).

An application of the embodiment to the quad-tree will be described.

### [5] Application to the Quad-Tree

Each of the above-described mechanisms [1] through [4] is used as an independent mechanism and may be applied to the quad-tree.

If sizes of the cells of the quad-tree are increased, the number of the sets of the graphic data 5 being the search targets is increased. As a result, a search time is generally increased.

The sizes of the cells are set to be larger, and the mechanisms [1] through [4] are applied to the sets of the graphic data 5 in each of the cells. Accordingly, it is possible to realize the high speed search for a case of conducting the search without degrading the search efficiency, and further by suppressing the increase of the data scale due to a data division and by shifting the local area.

In the following, a graphic search apparatus for performing a process according to the embodiment will be described.

### (6) Graphic Search Apparatus

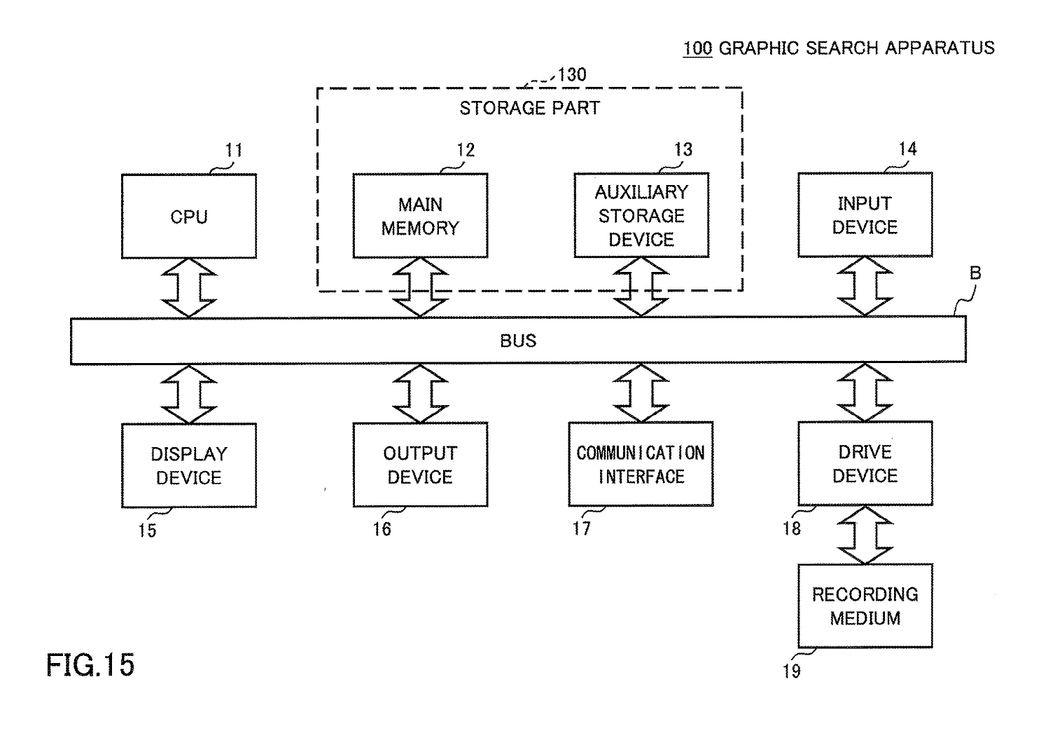

A graphic search process is conducted by a graphic search apparatus 100 (FIG. 15). The graphic search process is conducted in a two dimensional graphic process, and in response to an instruction of a designer.

FIG. 15 is a diagram illustrating a hardware configuration of the graphic search apparatus 100. In FIG. 15, the graphic search apparatus 100 is regarded as a terminal controlled by a computer, and includes a CPU (Central Processing Unit) 11, a main memory 12, an auxiliary storage device 13, an input device 14, a display device 15, an output device 16, a communication interface 17, and a drive device 18, which are mutually connected via a bus B.

The CPU 11 controls the graphic search apparatus 100 in accordance with a program stored in the main memory 12. The main memory 12 may include a RAM (Random Access Memory), a ROM (Read-Only Memory), and the like, and stores the program executed by the CPU 11, data used in a process of the CPU 11, data acquired in the process of the CPU 11, and the like. Also, a portion of an area of the main memory is assigned as a working area used by the process of the CPU 11.

The auxiliary storage device 13 includes a hard disk drive, and stores data such as the program for executing various processes. A part of the program stored in the auxiliary storage device 13 is loaded into the main memory 12, and executed by the CPU 11, so as to realize the various processes. A storage part 130 includes the main memory 12 and/or the auxiliary storage device 13.

The input device 14 includes a mouse, a keyboard, and the like, and is used for the designer of the LSI 2 as a user to input various information items for the process conducted by the graphic search apparatus 100. The display device 15 displays various information items under a control of the CPU 11. The output device 16 includes a printer and the like, and is used to output various information items in response to an instruction of the user. The communication interface 17 may be used to connect the Internet, a LAN (Local Area Network), and the like, and to control communications with an external apparatus.

The program for realizing the process conducted by the graphic search apparatus 100 may be provided to the graphic search apparatus 100 by a recording medium 19 such as a CD-ROM (Compact Disc Read-Only Memory) or the like. The recording medium 19 may be formed by a non-transitory (or tangible) computer-readable recording medium. When the recording medium 19 storing the program is set in the drive device 18, the drive device 18 reads out the program from the recording medium 19. The program is installed into the auxiliary storage device 13 via the bus B. Then, when the program is executed, the process is begun by the CPU 11 in accordance with the program which is installed into the auxiliary storage device 13. The recording medium 19 for storing the program is not limited to the CD-ROM. Any computer-readable recording medium may be used as the recording medium 19. In addition to the CD-ROM, a portable recording medium such as a Digital Versatile Disk (DVD), a Universal Serial Bus (USB) memory, a semiconductor memory such as a flash memory, or the like may be used as the computer-readable recording medium 19.

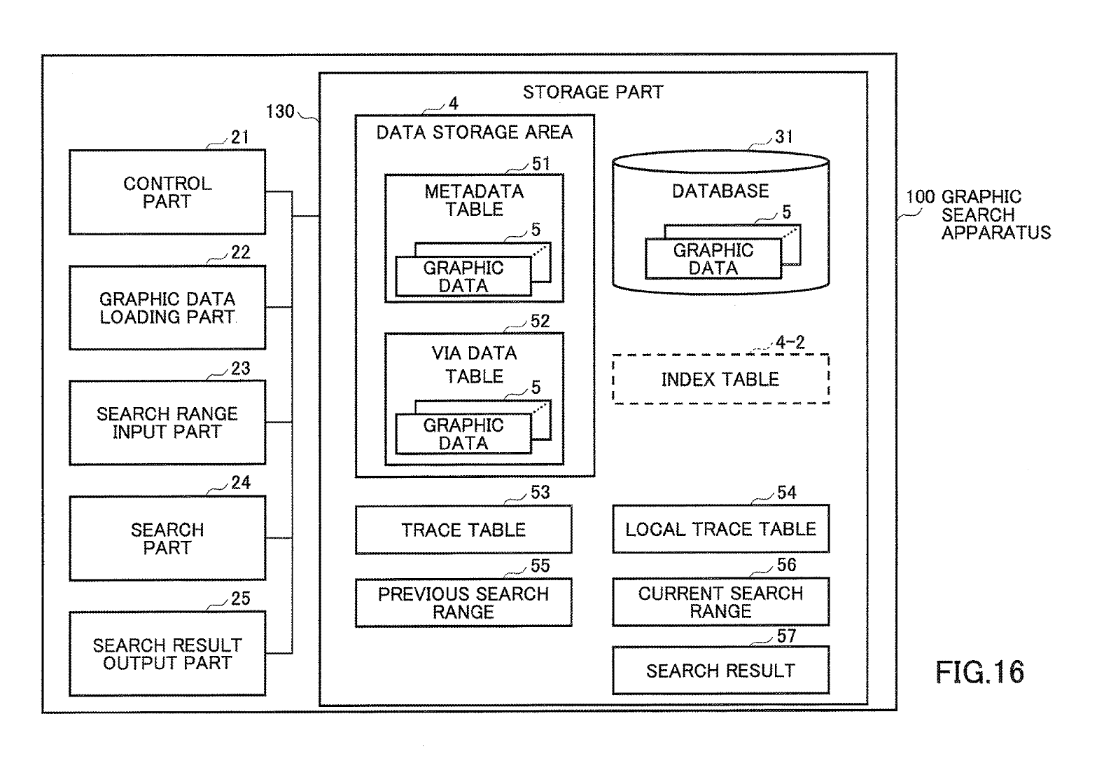

FIG. 16 is a diagram illustrating a functional configuration example of the graphic search apparatus 100. In FIG. 16, the graphic search apparatus 100 includes a control part 21, a graphic data loading part 22, a search range input part 23, a search part 24, and a search result output part 25. The control part 21, the graphic data loading part 22, the search range input part 23, the search part 24, and the search result output part 25 are realized by processes which are performed in accordance with respective programs executed by the CPU 11. The graphic data loading part 22, the search range input part 23, the search part 24, and the search result output part 25 are respectively controlled by the control part 21.

Also, the storage part 130 includes a database 31, a data storage area 4, the index table 4-2, the trace table 53, the local trace table 54, a previous search range 55, a current search range 56, a search result 57, and the like.

The control part 21 controls the entire graphic search process using the trace table 53 and the local trace table 54, and controls the graphic data lading part 22, the search range input part 23, the search part 24, and the search result output part 25.

The graphic data loading part 22 sorts the graphic data 5 of the wirings and the vias which are read from the database 31, for each of the traces on each of the wiring layers in the trace direction by using the reference point, and stores the sort result in the data storage area 4. The graphic data 5 read from the database 31 stores as the metal data table 51 and the via data table 52 in the data storage area 4. The graphic data 5 are sorted in the metal data table 51 and the via data table 52.

Alternately, in a case of using the index table 4-2, instead of sorting the graphic data 5, the graphic data loading part 22 sorts and stores the indexes pointing to respective sets of the graphic data 5 in the index table 4-2. In this case, it is possible to reduce a data movement amount of a sort process (FIG. 4), and to also reduce a sort time for the large scale data.

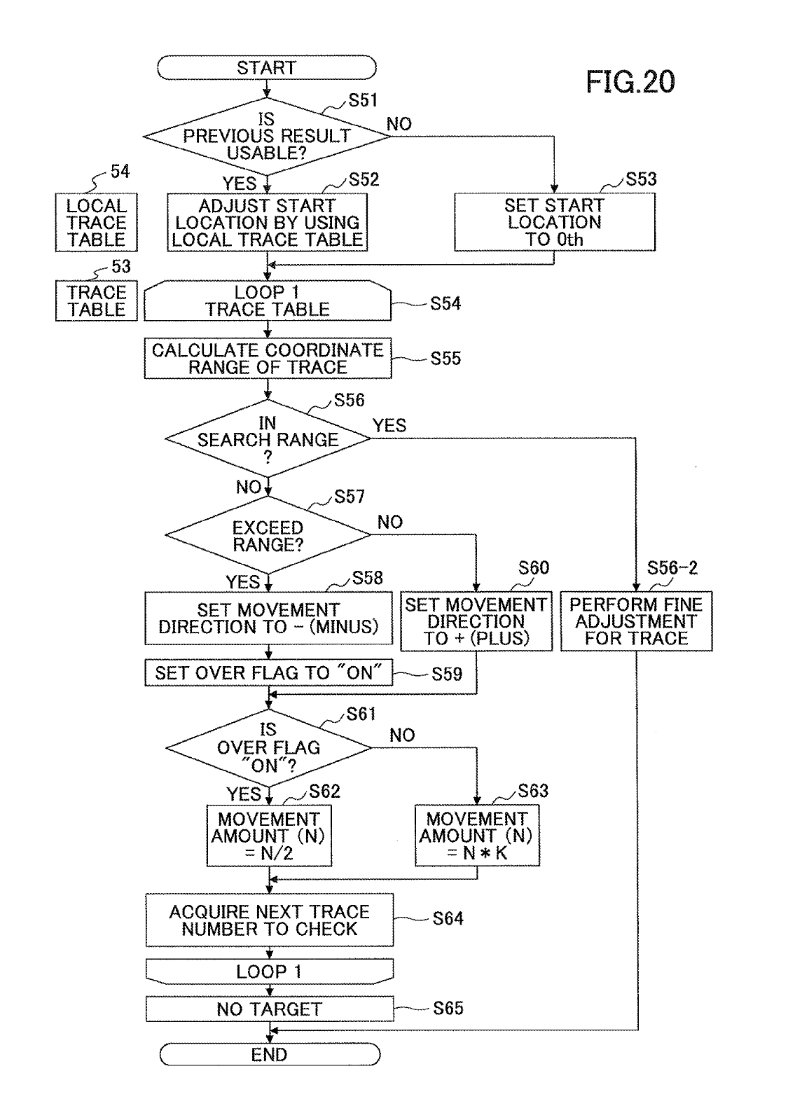

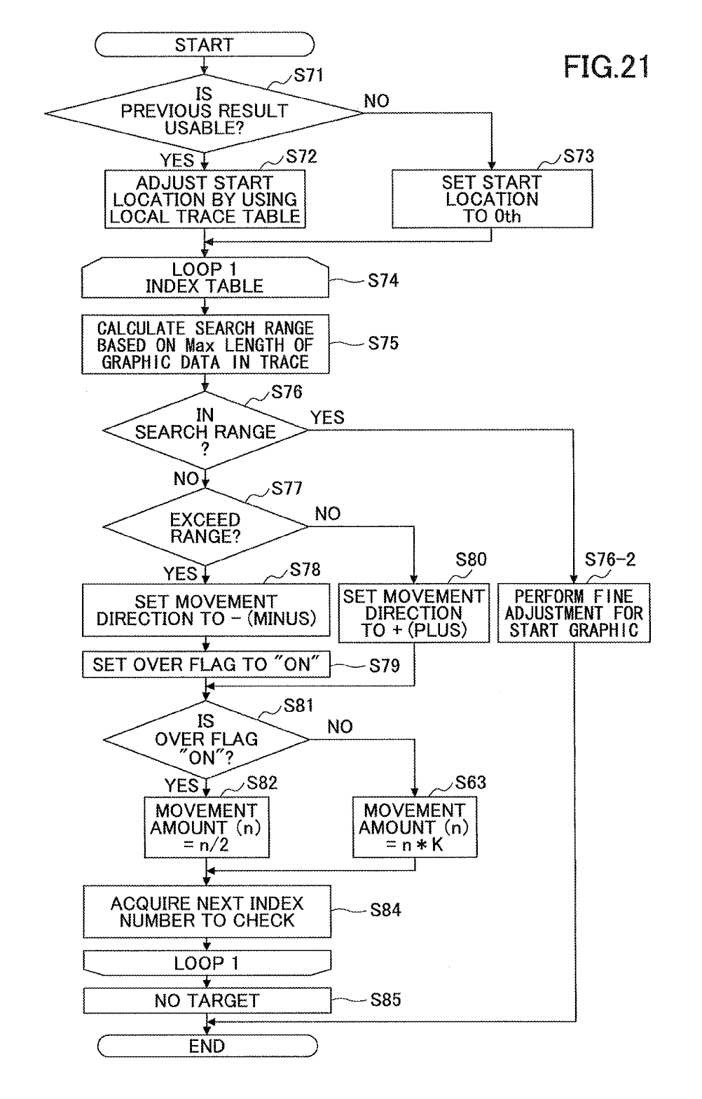

By the search range input part 23, a coordinate range of the search target is indicated. The search part 24 determines a difference between the previous search range 55 which is a search range previously indicated and the current search range 56 which is another search range newly indicated. If the local trace is usable, the skip search is performed by using the local trace table 54. If the difference between the previous search range 55 and the current search range 56, or if the local trace table 54 is not created, the binary search is used. The search targets are extracted while creating the local trace table 54. In flowcharts in FIG. 20 and FIG. 21 described later, for the sake of simplicity, instead of using the binary search, the skip search is applied. In a case in which the data scale is smaller, there is no a performance difference even if the skip search is entirely used to simplify the search process.

The search result output part 25 retains the data extracted by the search part 24.

The database 31 is used to store and manage data pertinent to the fabrication of the LSI 2, the data including the graphic data 5 such as shapes or the like of the wirings and vias of the LSI 2. By the graphic data loading part 22, the graphic data 5 of the wirings and vias are loaded from the database 31, and are sorted and stored in the data storage area 4.

As described in FIG. 4C, in the index table 4-2, the indexes respectively pointing to the graphic data A through D are sorted and stored. In a case of directly sorting the graphic data 5 stored in the metal data table 51 and the via data table 52 in the data storage area 4 by the graphic data loading part 22, the index table 4-2 is not used.

As described in FIG. 9, the trace table 53 indicates the link to the graphic data 5 of a beginning for each of the traces in the sets of the graphic data 5 being sorted beforehand. In the data storage area 4 or the index table 4-2, the graphic data 5 being the beginning for each of the traces are linked from the trace table 53.

As described in FIG. 14, the local trace table 54 stores and manages the trace numbers and the links toward the graphic data 5 being the targets for the search range. The local trace table 54 is updated during the search process and indicates data used in a previous search.

The previous search range 55 is the search range previously indicated and the current search range 56 is another search range newly indicated. The previous search range 55 and the current search range 56 are referred to by the search part 24. The search result 57 includes the graphic data 5 which are determined to be in the search range.

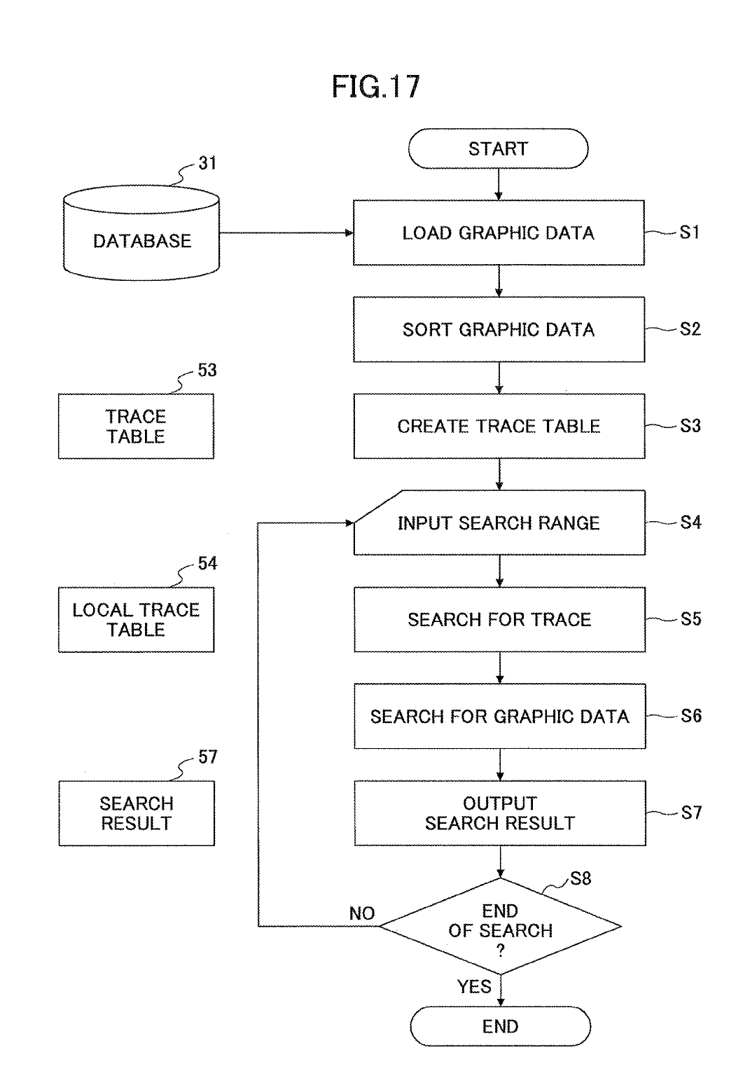

The graphic search process conducted by the graphic search apparatus 100 is briefly described with reference to FIG. 17. FIG. 17 is a flowchart for briefly explaining the graphic search process. In the graphic search process illustrated in FIG. 17, the graphic data loading part 22 reads out the sets of the graphic data 5 from the database 31 and stores the sets of the graphic data 5 in the data storage area 4 (step S1). The graphic data loading part 22 sorts the sets of the graphic data 5 in the data storage area 4 or by using the index table 4-2 (step S2)and creates the trace table 53 (step S3).

The control part 21 inputs the search range by the search range input part 23 (step S4). The control part 21 controls the search part 24 to search for the trace to be the target in the search range input by the search range input part 23 (step S5), and searches for the graphic data 5 (step S6). The search result 57 is stored in the storage part 130. Then, the control part 21 controls the search result output part 25 to output the search result 57 including the graphic data 5 to be the target for the search result (step S7).

The control part 21 determines whether the graphic search ends (step S8). When the control part 21 determines that the graphic search does not end, the control part 21 goes back to the step S4, and repeats the above-described process. On the other hand, when the graphic search ends, the control part 21 terminates the graphic search process.

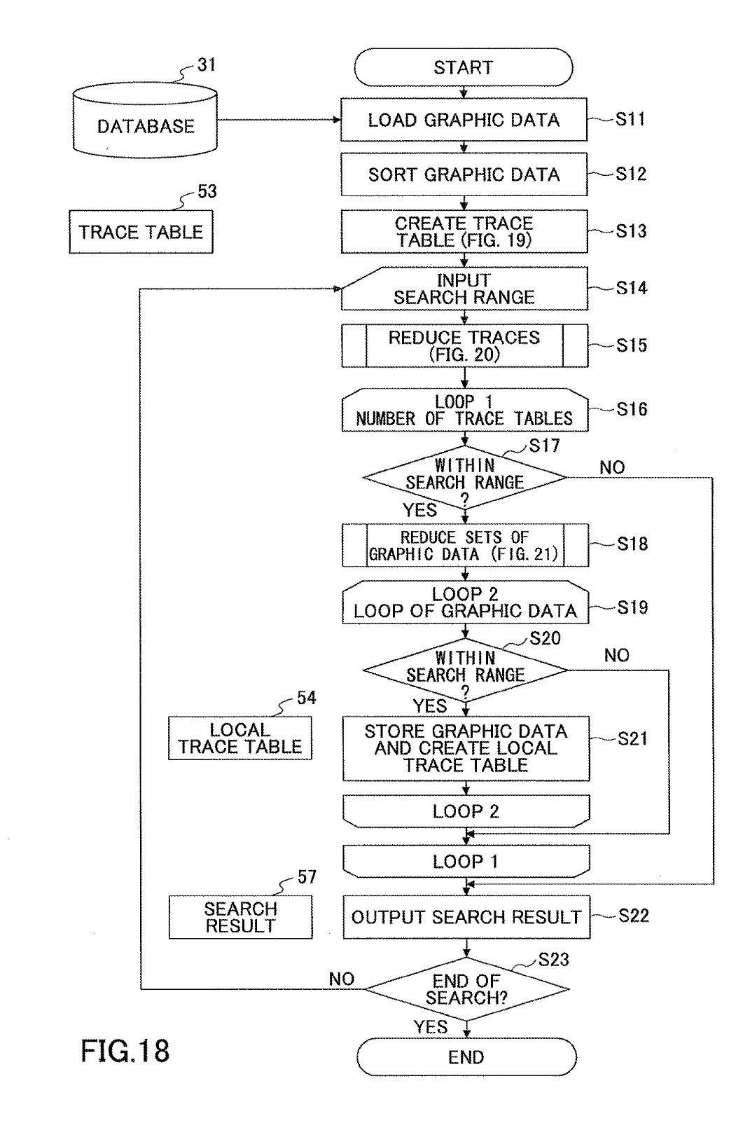

FIG. 18 is a flowchart for explaining the graphic search process in detail. In FIG. 18, the graphic data loading part 22 reads out the sets of the graphic data 5 from the database 31, and stores the sets of the graphic data 5 in the data storage area 4 (step S11).

The graphic data loading part 22 sorts the sets of the graphic data 5 by using the reference point (step S12). In a case in which the index table 4-2 exists, after creating the index pointing to the graphic data 5 and storing the index table 4-2, the graphic data loading part 22 sorts the index table 4-2 based on the reference point of the graphic data 5.

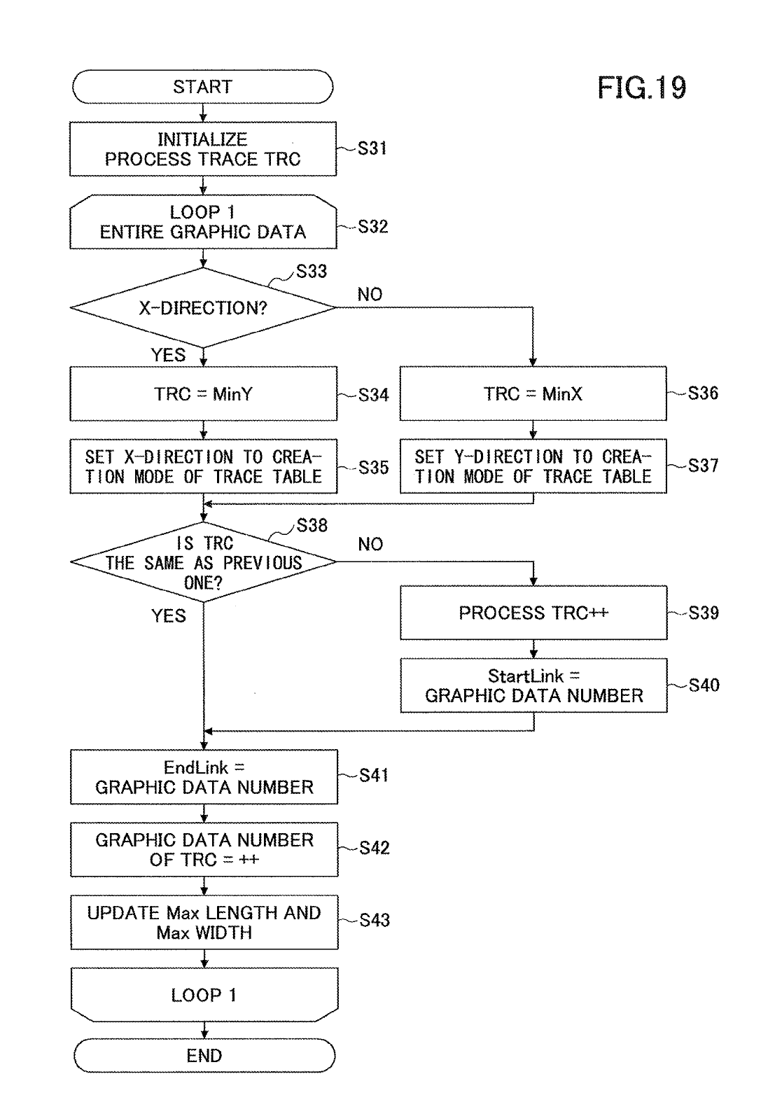

The control part 21 refers to the index table 4-2 or the sets of the graphic data 5 stored in the data storage area 4 in which the sort process is conducted by the graphic data loading part 22, and creates the trace table 53 which links to the graphic data 5 being the beginning of each of the traces as illustrated in FIG. 7 (step S13). Also, in this case, in the sets of the graphic data 5 included in the same trace, the maximum length (Max length) and the maximum width (Max width) are stored in the trace table 53. A creation process of the trace table 53 conducted by the control part 21 will be described in detail with reference to FIG. 19.

The search range input part 23 inputs (Xmin, Ymin) and (Xmax, Ymax) indicating the search range of the graphics in the wiring process or in response to the instruction of the designer, and stores the search range as the current search range 56 in the storage part 130 (step S14).

The control part 21 reduces the number of the traces by the search part 24 (step S15). As illustrated in FIG. 10, a first trace number is acquired to check the trace coordinate to be the search range (trace beginning extraction). A trace reduction process conducted by the search part 24 is described in detail in FIG. 20.

A loop is performed from the trace number extracted as a trace beginning in the step S15 to a last trace number (step S16: Loop 1). For each loop, it is determined whether the trace is outside of the search range (step S17: a range check of the trace coordinate). It is determined whether the trace is outside of the search range, by evaluating the Max width with respect to the search range 6 as illustrated in FIG. 10. When the trace is outside of the search range, the control part 21 terminates the Loop 1 and advances to step S22.

When the trace is within the search range, the control part 21 skips the graphic data 5 which are grouped in the traces being outside of the search range, and extracts a beginning of the sets of the graphic data 5 for each of the traces to be the search targets (FIG. 12 and FIG. 13). A graphic data reduction process for reducing the sets of the graphic data 5 to be the search targets is performed (step S18). In the graphic data reduction process, the Max length as illustrated in FIG. 10 is referred to. The graphic data reduction process conducted by the search part 24 will be described with reference to FIG. 21.

The control part 21 repeats a search of the graphic data 5 to be the search target until an end of the same trace (step S19: Loop 2). The control part 21 determines whether the reference point of the graphic data 5 is in the search range (step S20). When the reference point exceeds the search range, the control part 21 terminates the Loop 2, and advances to step S22.

On the other hand, when the reference point of the graphic data 5 is in the search range, the control part 21 controls the search part 24 to store the search result 57 including the graphic data 5 in the search range to the storage part 130, and simultaneously creates the local trace table 54 (step S21). All sets of the graphic data 5, which may be candidates in the search range, are checked, and stored in the storage part 130 when the search range and a rectangle represented by the graphic data 5 are overlapped.

When the Loop 2 and Loop 1 are terminated, the control part 21 controls the search result output part 25 to output the search result 57 stored in the storage part 130 (step S22). When the search range is indicated by the designer, the search result output part 25 outputs contents of the search result 57 to the display device 15 or the output device 16.

FIG. 19 is a flowchart for explaining the creation process of the trace table 53 in the step S13 in FIG. 18. In FIG. 19, the control part 21 initializes a process trace TRC (step S31).

The control part 21 conducts a Loop 1 until an end of the entire sets of the graphic data (step S32: Loop 1). The control part 21 sequentially reads out the graphic data 5 from the data storage area 4, and determines whether a direction of the wiring (trace direction) is the x-direction (step S33). As illustrated in FIG. 5, a value of the direction (FIG. 5) is referred to as the direction of the wiring (trace direction).

When the x-direction is indicated, the control part 21 sets MinY (y-coordinate of the reference point) to the process trace TRC (step S34), and sets the x-direction to a creation mode for creating the trace table 53 (step S35). On the other hand, when the y-direction is indicated, the control part 21 sets MinX (x-coordinate of the reference point) to the process trace TRC (step S36), and sets the y-direction to the creation mode for creating the trace table 53 (step S37).

After that, the control part 21 determines whether the process trace TRC is the same as a previous trace (step S38). When the process trace TRC is the same as the previous trace, the control part 21 advances to the step S41. When the process trace TRC is not the same as the previous trace, the control part 21 adds a new process trace TRC to the trace table 53 (step S39). The graphic data number of the graphic data 5 is set to the StartLink of the new process trace TRC (step S40).

The control part 21 sets the graphic data number of the graphic data 5 to the EndLink of the process trace TRC of the trace table 53 (step S41), and increments the graphic data number of the process trace TRC by 1 (step S42).

The control part 21 updates the Max length and the Max width of the process trace TRC of the trace table 53 (step S43). When Xlen of the graphic data 5 read from the data storage area 4 is greater than the Max length, the control part 21 updates the Max length of the process trace TRC with Xlen. When Ylen of the graphic data 5 read from the data storage area 4 is greater than the Max width, the control part 21 updates the Max width of the process trace TRC with Ylen.

When the above described process is performed for all sets of the graphic data 5 stored in the data storage area 4, the control part 21 terminates the creation process of the trace table 53.

FIG. 20 is a flowchart for explaining the trace reduction process in the step S15 in FIG. 18. In the trace reduction process, the first trace number is acquired to determine the trace coordinate to be the search range.

In FIG. 20, the search part 24 checks whether a previous result is usable (step S51). When a previous result is usable, the search part 24 uses the local trace table 54 and adjusts a start location (step S52). When a previous local trace table 54 (the previous trace range) is usable, that is, when the previous search range and the current search range are overlapped, an initial value of the trace is set to extract the beginning of the traces by using the previous local trace table 54.

On the other hand, when the previous trace table 54 as a previous result is not usable, the search part 24 sets a 0^{th} trace as the start location (step S53). When the previous local trace table 54 (the previous trace range) is irrelevant, the start point of the skip search is set to a beginning (0) of the line data (FIG. 3). In the flowchart in FIG. 20, the skip search is used as an example. Instead of the skip search, the binary search is also possible to be used.

The search part 24 refers to the trace table 53, and specifies the trace to be the target in the search range by starting from the trace of the start location (step S54: Loop 1). The search part 24 sequentially reads the traces from the start location one by one in the trace table 53, and calculates the coordinate range (step S55). When the creation mode indicates the x-direction for creating the trace table 53, the search part 24 calculates a range of graphics included in this trace based on the Max width of the graphics in the same trace and the trace coordinate.

Then, the search part 24 determines whether this trace is in the search range (step S56: FIG. 10). When this trace is in the search range, the search part 24 performs a fine adjustment for this trace (step S56-2), and terminates the trace reduction process. The search part 24 acquires a beginning trace with respect to the search range when the trace corresponds to the search range. A start point of the trace is acquired while checking a range of the graphic data 5 in the trace by shifting the trace in the “−” (minus) direction. In a case of using the skip search, a range is reduced by using another Max width of the entire traces, which is different from the Max width for each of the traces and is a greatest value in all Max widths of respective traces. It is determined for each of the traces whether the trace is related to the search range. Thus, after a reduction is made using the Max width in the entire traces, a check is conducted in detail by a trace basis. The start point of the trace used in the check of the trace basis.

On the other hand, when this trace outside of the search range, the search part 24 determines whether this trace exceeds the range (step S57). If this trace exceeds the range, the search part 24 sets a movement direction to be “−” (minus) (step S58), and sets an overflag to “ON” (step S59).

In a case of exceeding an upper trace number with respect to the search range in a middle of the skip search, the movement amount is switched from an increase to a decrease. In a case of exceeding the search range, the overflag in the storage part 130 is set to “ON”, and is referred to when the movement amount is calculated in a succeeding process.

On the other hand, when the trace does not exceed the search range, the search part 24 sets the movement direction to “+” (plus) (step S60). When the trace number of the skip search is outside of the search range, and when the trace number exceeds the upper trace number of the search range, the search part 24 sets a next trace subject to check in the “−” (minus) direction from a current trace. When the trace number is outside of the search range, and when the trace number is less than a lower trace number of the search range, the search part 24 sets the next trace subject to check in the “+” (plus) direction.

The search part 24 determines whether the overflag indicates “ON” (step S61). When the overflag indicates “ON”, the search part 24 reduces the movement amount to be ½ (movement amount (N)=N/2), similar to the binary search (step S62). On the other hand, when the overflag indicates “OFF”, the search part 24 increases the movement amount K times (K denotes a constant being 2 or more) (step S63).

Then, the search part 24 calculates the next trace number to check based on a current trace number, the movement direction acquired in the steps S58 or S60, and the movement amount acquired in the steps S62 or S63 (step S64), goes back to the step S55, and repeats the above described process in the same manner (Loop 1). When the Loop 1 in the step S54 ends, the search part 24 determines that there is no trace to be the target in the trace table 53 (step S65), and terminates the trace reduction process.

FIG. 21 is a flowchart diagram for explaining the graphic data reduction process in the step S18 in FIG. 18. In FIG. 21, a case of using the index table 4-2 will be described.

In FIG. 21, the search part 24 determines whether the previous result is usable (step S71). When the previous result is usable, the search part 24 adjusts the start location by using the local trace table 54 (step S72). When the previous local trace table 54 (the previous trace range) is usable, that is, when the previous search range 55 and the current search range 56 are partially overlapped with each other, the search part 24 determines the start location by using the previous local trace table 54, as an initial value of the trace which is referred to when the beginning of the trace is extracted.

On the other hand, when the previous result is not usable, the search part 24 sets the start location to the 0^{th} trace (step S73). When the previous local trace table 54 (the previous trace range) is irrelevant, the start point of the skip search is set to the beginning (0) of the line data (FIG. 3). In the flowchart in FIG. 21, the skip search is used as an example. Instead of the skip search, the binary search is also possible to be used.

The search part 24 searches for, by the skip search, the graphic data 5 existing in the traces managed in the trace table 53 for the search targets determined in step S16 in FIG. 18 (step S74: Loop 1).

The search part 24 sequentially reads out the traces one by one from the trace of the start location in the trace table 53, and calculates to find the reference point of the graphic data 5 with respect to the search range based on the Max length of the graphic data 5 in the trace (step S75). In a case in which the creation mode indicates the x-direction for creating the trace table 53, the search part 24 determines where the reference point of the graphic to be checked is located, based on the Max length in the trace and the coordinate (MinX) of the search range. A checking reference point (x-coordinate) is acquired as follows:

SX=MinX−Max length.

After that, the search part 24 determines whether the graphic data 5 are in the search range (step S76: FIG. 10). When PoxX denotes the reference point of the graphic data 5 in the trace, the search part 24 searches for the graphic data 5 which satisfies the following:

PoxX>SX.

Moreover, the search part 24 determines whether the graphic data 5 are the target with respect to the search range, by using a length based on the graphic data 5. The graphic data 5 which are found first are defined as the search start point.

When the graphic data 5 are in the search range, the search part 24 slightly adjusts the graphic data 5 to be the beginning (step S76-2), and terminates the graphic data reduction process for reducing the sets of the graphic data 5 to be the search target. In order to specify the graphic data 5 to be the beginning with respect to the search range when the multiple sets of the graphic data 5 are the search target, the search part 24 shifts the trace toward the “−” (minus) direction (decreases the trace number), and checks the range of the graphic data 5 in the trace, so as to acquire the graphic data 5 to be the beginning.

On the other hand, when the graphic data 5 are outside of the search range, the search part 24 determines whether the graphic data 5 exceeds the search range (step S77). When the graphic data 5 exceeds the search range, the search part 24 sets the “−” (minus) direction to the movement direction (step S78), and sets the overflag to “ON” (step S79).

When the graphic data 5 exceeds the search range with respect to a coordinate of the trace direction (the x-coordinate if the trace direction is the x-direction, or the y-coordinate if the trace direction is the y-direction) in a middle of the skip search, the search part 24 switches the movement amount from the increase to the decrease. When the trace number exceeds the search range, the search part 24 sets the overflag in the storage part 130 to “ON”. The overflag is referred to when the movement amount is calculated later.

On the other hand, when the graphic data 5 do not exceed the search range, the search part 24 sets the movement direction to the “+” direction (step S80). When the graphic data 5 is outside of the search range and exceed the search range, the search part 24 sets the movement direction to the “−” (minus) direction from current graphic data 5 to acquire next graphic data 5 to check. In the other case, the search part 24 sets the movement direction to the “+” (plus) direction to acquire the next graphic data 5 to check.

The search part 24 determines whether the overflag indicates “ON” (step S81). When the overflag indicates “ON”, the search part 24 reduces the movement amount to ½ (movement amount (N)=N/2), similar to the binary search (step S82). On the other hand, when the overflag indicates “OFF”, the search part 24 increases the movement amount K times (K denotes the constant being 2 or more) (step S63).

Then, the search part 24 calculates the number of the next graphic data 5 to check based on the number of the current graphic data 5, the movement direction acquired in the steps S78 or S80, and the movement amount acquired in the steps S82 or S83 (step S84), goes back to the step S75, and repeats the above describe process in the same manner (Loop 1). When the Loop 1 of the step S74 ends, the search part 24 determines that there is no graphic data 5 to be the target in the index table 4-2 (step S85), and terminates the graphic data reduction process.

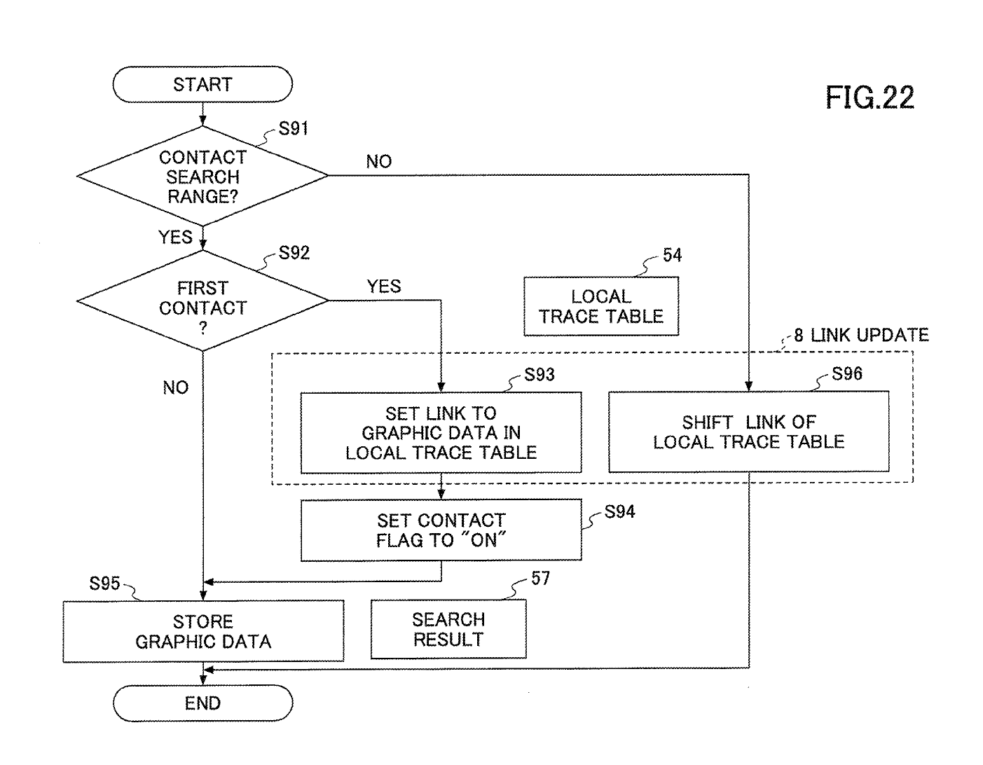

FIG. 22 is a flowchart for explaining a process in the step S21 in FIG. 18. The process depicted in the flowchart in FIG. 22 is performed for each set of the graphic data 5 in the same trace. A link update of the local trace table 54 and a process for storing the search result 57 are conducted. In FIG. 22, the search part 24 determines whether the graphic represented by the graphic data 5 contacts the search range (step S91).

When the graphic represented by the graphic data 5 contacts the search range, the search part 24 determines whether the graphic data 5 represents a first graphic which contacts the search range, by checking whether a contact flag stored in the storage part 130 is set to “ON” (step S92). When it is determined that the graphic data 5 does not represent the first graphic which contacts the search range (when the contact flag indicates “ON”), the search part 24 advances to step S95.

On the other hand, when it is determined that the graphic data 5 represents the first graphic which contacts the search range (when the contact flag indicates “OFF”), the search part 24 sets the link pointing to the graphic data 5 in the local trace table 54 (step S93), and sets the contact flag to “ON” (step S94).

The search part 24 additionally stores the graphic data 5 to the search result 57 in the storage part 130 (step S95), and terminates the graphic data reduction process. The number specifying the graphic data 5 may be stored in the search result 57.

When the graphic represented by the graphic data 5 does not contact the search range, the search part 24 shifts the link of the local trace table 54 (step S96), and terminates the graphic data reduction process.

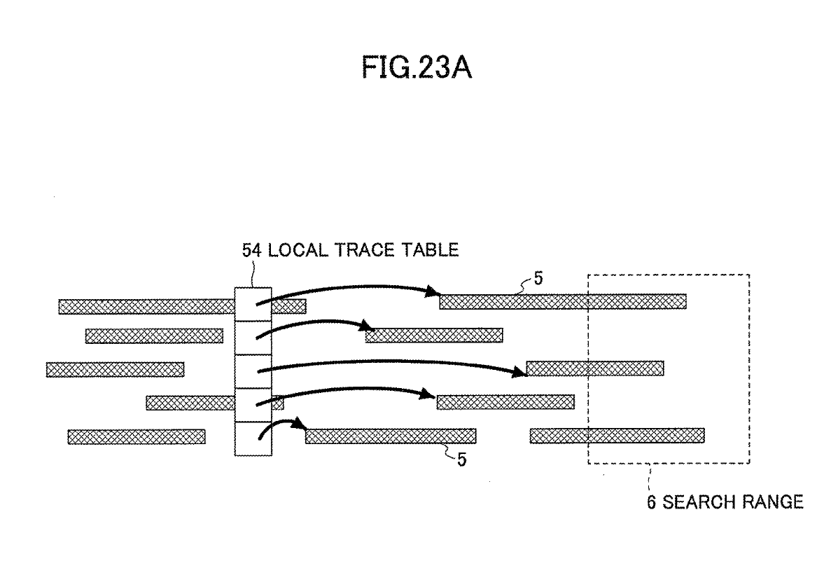

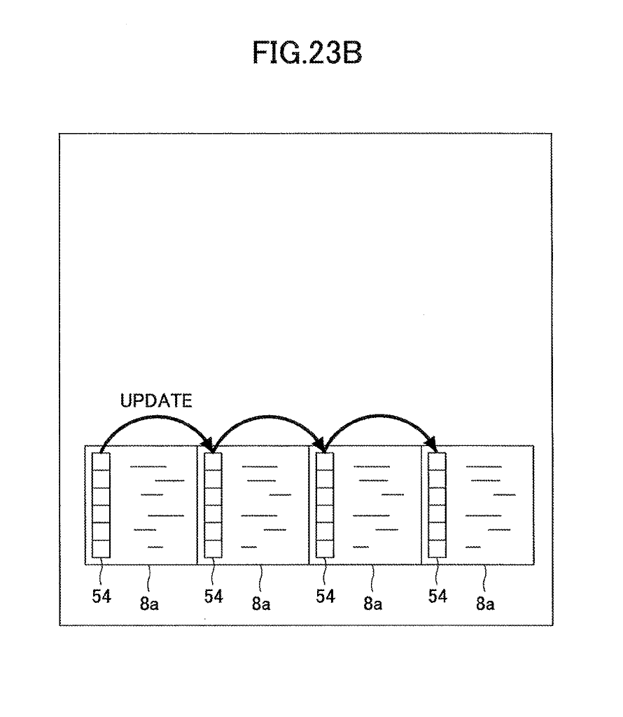

The link update in the steps S93 and S96 will be described with reference to FIG. 23A and FIG. 23B. FIG. 23A and FIG. 23B are diagrams for explaining the link update. FIG. 23A illustrates a state in which the local trace table 54 links to multiple sets of the graphic data 5 representing the first graphics in the process in the step S93. The graphic data 5 representing the first graphics which contact the search range are linked respective to the traces targets for the search range in the local trace table 54.

Also, FIG. 23B depicts an operation for shifting the links of the local trace table 54, the operation conducted by the process in the step S96 unless the graphic data 5 representing the first graphics contacting the search range are detected. In a case in which the creation mode indicates the x-direction, unless the graphic data 5 representing the first graphics contacting the search range are detected, the links of the local trace table 54 are updated by shifting in the x-direction.

By updating the links of the local trace table 54, a local area 8a is shifted.

By controlling the graphic data loading part 22, the search range input part 23, the search part 24, and the search result output part 25, the control part 21 may recursively divide the two dimensional area where the graphic data 5 exist, into four areas (cells or buckets) (the quad-tree). Then, the search part 21 may perform the above described graphic search process with respect to the graphic data 5 existing in the cell for each of the cells.

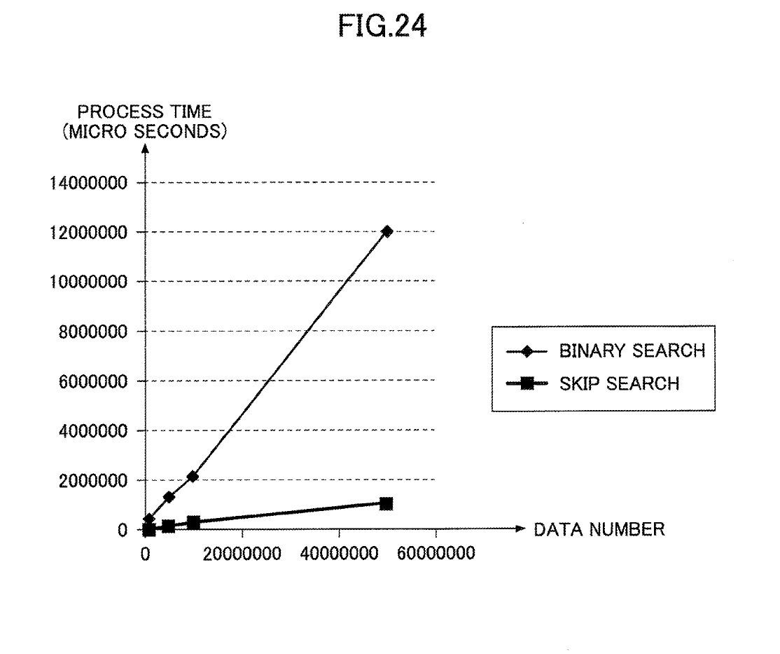

FIG. 24 is a diagram illustrating a comparison of the process time. In FIG. 24, a horizontal axis indicates a data number, and a longitudinal axis indicates the process time (micro seconds). Compared with the binary search where the embodiment is not applied, it is possible for the skip search where the embodiment is applied to significantly decrease the process time corresponding to an increase of the data number.

As described above, the graphic search apparatus 100 according to the embodiment manages a large amount of the graphic data 5 in the two dimensional space such as the fabrication data of the LSI 2. In a case of performing the graphic search process, in the graphic search apparatus 100, the sets of the graphic data 5 are arrayed by a simple sort of one dimension. After that, the graphic search is repeated by the skip search using the trace table 53 managing the coordinate range and the local trace table 54 which manages a previous search start point (graphic data 5 being linked) for a local search, in which the sets of the graphic data 5 are chained to shift the local area 8a. It is possible to realize less memory use and the high speed search independent of the total number of the sets of the graphic data 5 by the skip search according to the embodiment.

According to the embodiment, in the graphic search, it is possible to search in an area near the search start at higher speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A graphic search apparatus, comprising:
a storage part configured to store first trace information including information pertinent to graphic data, the first trace information acquired by tracing sets of the graphic data included in a search range based on a sort result from sorting the sets of the graphic data included in the search range in which one of multiple areas included in a predetermined area is set as the search range; and
a control part configured to start from beginning graphic data corresponding to the information included in the first trace information stored in the storage part, to search for the graphic data toward an adjacent search range to the search range including the beginning graphic data, and to control a process for updating the first trace information.

2. The graphic search apparatus as claimed in claim 1, wherein
the storage part stores second trace information in which a link pointing to first graphic data, and a maximum length and a maximum width of a graphic represented by the graphic data correspond to a trace number for specifying each trace in the sets of the graphic data traced in accordance with a trace direction for each of traces;
the traces are acquired by dividing the predetermined area by a predetermined value in a vertical direction with respect to the trace direction in the predetermined area; and
the graphic search apparatus further comprises:
a search part controlled by the control part and configured to update the first trace information by the trace number of a target trace to be a target for the adjacent search range and the link pointing to target graphic data to be a search target in the trace,
wherein the target trace and the target graphic data are searched for by shifting the search range to the adjacent search range
by skipping the graphic data of the trace at a distance greater than the maximum width from the adjacent search range by referring to the second trace information stored in the storage part, and
by skipping the graphic data in which an origin is placed at a distance greater than the maximum length from the adjacent search range in coordinates in the trace direction.

3. The graphic search apparatus as claimed in claim 2, wherein the search part includes a trace reduction part configured to reduce the traces to the target trace in the adjacent search range,
by setting a movement direction to a minus direction when the trace number of a trace indicates outside of the adjacent search range, and the trace number is greater than an upper trace number of the adjacent search range, and
by setting the movement direction to a plus direction when the trace number of the trace indicates outside of the adjacent search range, and the trace number is less than a lower trace number of the adjacent search range,
in a case of skipping the trace which is at a distance greater than the maximum width from the adjacent search range.

4. The graphic search apparatus as claimed in claim 3, wherein the search part includes a graphic data reduction part configured to reduce the sets of the graphic data in the adjacent search range,
by setting the movement direction to the minus direction when the graphic data exceed a front of the adjacent search range in the trace direction and are outside of the adjacent search range, and
by setting the movement direction to the plus direction when the graphic data exceed a rear of the adjacent search range in the trace direction and are outside of the adjacent search range,
in a case of skipping the graphic data which are at a distance greater than the maximum length from the adjacent search range in the coordinates in the trace direction in a search of the graphic data for each of the traces in the adjacent search range, the traces being reduced by the trace reduction part.

5. The graphic search apparatus as claimed in claim 3, wherein the search part increases the movement amount in the movement direction, which is set after the graphic data are skipped, by reaching the adjacent search range or passing the adjacent search range, and decreases the movement amount when passing the adjacent search range.

6. The graphic search apparatus as claimed in claim 2, wherein the control part controls the search part to search the graphic data in a cell for each of the cells which are acquired by recursively dividing the predetermined area into four.

7. The graphic search apparatus as claimed in claim 2, wherein
a plurality of the predetermined areas are laminated, and
the control part is configured to
acquire the link pointing to the first graphic data, and the maximum length and the maximum width in the sets of the graphic data in the same trace, by referring to a sort result for each of the traces, in which the traces are acquired by dividing the predetermined area by a predetermined value in a vertical direction with respect to the trace direction defined for a layer in each of the predetermined areas, and
create, in the storage part, the second trace information in which the link, and the maximum length and the maximum width are corresponded to the trace number.

8. The graphic search apparatus as claimed in claim 2, wherein
the predetermined area is an area of a wiring layer of a large scale integration;
the graphic data represent a wiring arranged on the wiring layer; and
the control part sets a greater one of a length and a width of the wiring arranged on each wiring layer to the trace direction.

9. A graphic search method performed in a computer, the method comprising:
referring to first trace information including information pertinent to graphic data, in which the information is stored in a storage part and is acquired by tracing multiple sets of the graphic data included in a search range based on a sort result from sorting the multiple sets of the graphic data included in the search range corresponding to one of multiple areas included in a predetermined area;
starting from the graphic data corresponding to the information included in the first trace information stored in the storage part; and
controlling a process for updating the first trace information by searching the graphic data toward an adjacent search range of the search range including the graphic data.

10. A non-transitory computer-readable recording medium storing a program which, when executed by a computer, causes the computer to perform a graphic search process comprising:
referring to first trace information including information pertinent to graphic data, in which the information is stored in a storage part and is acquired by tracing multiple sets of the graphic data included in a search range based on a sort result from sorting the multiple sets of the graphic data included in the search range corresponding to one of multiple areas included in a predetermined area;
starting from the graphic data corresponding to the information included in the first trace information stored in the storage part; and
controlling a process for updating the first trace information by searching the graphic data toward an adjacent search range of the search range including the graphic data.
